(19) United States
(12) Patent Application Publication
(10) Pub. No.: US 2019/0155123 A1
(43) Pub. Date: May 23, 2019

(54) DIMMING DEVICE

(71) Applicant: Sharp Kabushiki Kaisha, Sakai City, Osaka (JP)

(72) Inventors: Nobuyuki ITO, Sakai City (JP); Eiji SATOH, Sakai City (JP)

(21) Appl. No.: 16/300,589

(22) PCT Filed: Apr. 27, 2017
(86) PCT No.: PCT/JP2017/016691

§ 371 Date: Nov. 12, 2018

(30) Foreign Application Priority Data
May 25, 2016 (JP) 2016-104174

(51) Int. Cl. G02F 1/167; G02F 1/1685

(52) U.S. Cl. CPC G02F 1/167; E06B 3/6722; G02F 2203/11; G02F 1/1685

(57) ABSTRACT

A transmittance of light is adjusted by more various operation modes compared to the related art. In a dimming device, in a case where an AC voltage having a first frequency and an amplitude equal to or greater than a first amplitude is applied, the transmittance of light in the first wavelength range is higher than that in a case where a flake is oriented in a direction shielding the light, and in a case where an AC voltage having a second frequency and an amplitude equal to or greater than a second amplitude is applied, the transmittance of light in the second wavelength range is higher than that in a case where a flake is oriented in a direction shielding the light. Here, the second amplitude is equal to or greater than the first amplitude.

### TECHNICAL FIELD

The present disclosure relates to a dimming device that adjusts a transmittance of light by controlling an orientation of a dimming member.

### BACKGROUND ART

In recent years, dimming devices (also referred to as dimming windows or smart windows) capable of adjusting a transmittance of light by various methods have been practically applied.

As an example, PTL 1 describes a light modulating device that uses an electrochromic light-modulating method for modulating light by reflection or transmission. Further, PTL 2 describes an infrared focusing device capable of switching transmission and reflection of infrared light by applying a voltage to a shape anisotropic member (also referred to as a light reflective material or a flake).

### CITATION LIST

### Patent Literature

PTL 1: Japanese Unexamined Patent Application Publication No. 1-48044 (Feb. 22, 1989)

PTL 2: International Publication No. 2015/40975 (Mar. 26, 2015)

### SUMMARY OF INVENTION

### Technical Problem

An object of one aspect of the present disclosure is to realize a dimming device capable of adjusting a transmittance of light by more various operation modes compared to the related art.

### Solution to Problem

In order to solve the above-described problem, according to one aspect of the present disclosure, there is provided a dimming device that adjusts a transmittance of light by controlling an orientation of a dimming member, the device including: a first dimming member that changes the transmittance of the light in a first wavelength range in accordance with a change in an orientation state; and a second dimming member that changes the transmittance of the light in a second wavelength range in accordance with the change in the orientation state, in which, in a case where an AC voltage having a first frequency and an amplitude equal to or greater than a first amplitude is applied, the transmittance of the light in the first wavelength range is higher than that in a case where the first dimming member is oriented in a direction shielding the light, in a case where an AC voltage having a second frequency and an amplitude equal to or greater than a second amplitude is applied, the transmittance of the light in the second wavelength range is higher than that in a case where the second dimming member is oriented in a direction shielding the light, and the second amplitude is equal to or greater than the first amplitude.

### Advantageous Effects of Invention

In the dimming device according to one aspect of the present disclosure, an effect that the transmittance of the light may be adjusted by more various operation modes compared to the related art is achieved.

### BRIEF DESCRIPTION OF DRAWINGS

FIGS. 1(a) to 1(c) are views each illustrating specific examples of dimming by a dimming device according to Embodiment 1.

FIG. 2 is a view schematically illustrating an internal configuration of the dimming device according to Embodiment 1.

FIGS. 3(a) and 3(b) are views each schematically illustrating an internal structure of a flake according to Embodiment 1.

FIGS. 4(a) to 4(c) are views each schematically illustrating an appearance of a flake according to Embodiment 1.

FIG. 5 is a view illustrating transmission characteristics of light of each flake illustrated in FIGS. 4(a) to 4(c).

FIGS. 6(a) to 6(d) are views each illustrating another specific example of the dimming by the dimming device according to Embodiment 1.

FIG. 7 is a view illustrating an example of a manufacturing method of the flake according to Embodiment 1.

FIG. 8(a) is an SEM image of a substrate after dry etching in the manufacturing method of FIG. 7, and FIG. 8(b) is a microscopic image of the substrate after peeling off a bottom portion of a base from the substrate in the manufacturing method.

FIG. 9 is a view illustrating an example of a manufacturing method of a flake according to Embodiment 2.

FIG. 10 is a view illustrating an example of a manufacturing method of a flake according to Embodiment 3.

FIG. 11 is a view illustrating an example of a manufacturing method of a flake according to Embodiment 4.

FIG. 12 is a functional block diagram illustrating a configuration of a main portion of a dimming system according to Embodiment 5.

FIG. 13 is a functional block diagram illustrating a configuration of a main portion of a dimming system according to Embodiment 6.

FIG. 14 is a functional block diagram illustrating a schematic configuration of a control unit in the dimming system according to one aspect of the present disclosure.

### DESCRIPTION OF EMBODIMENTS

### Embodiment 1

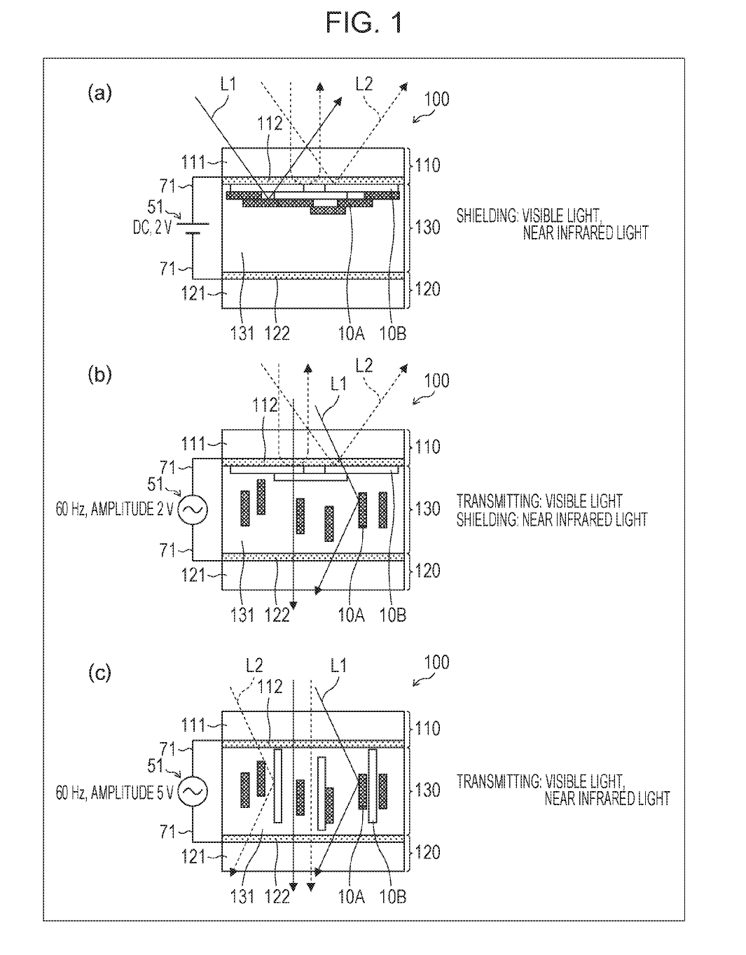

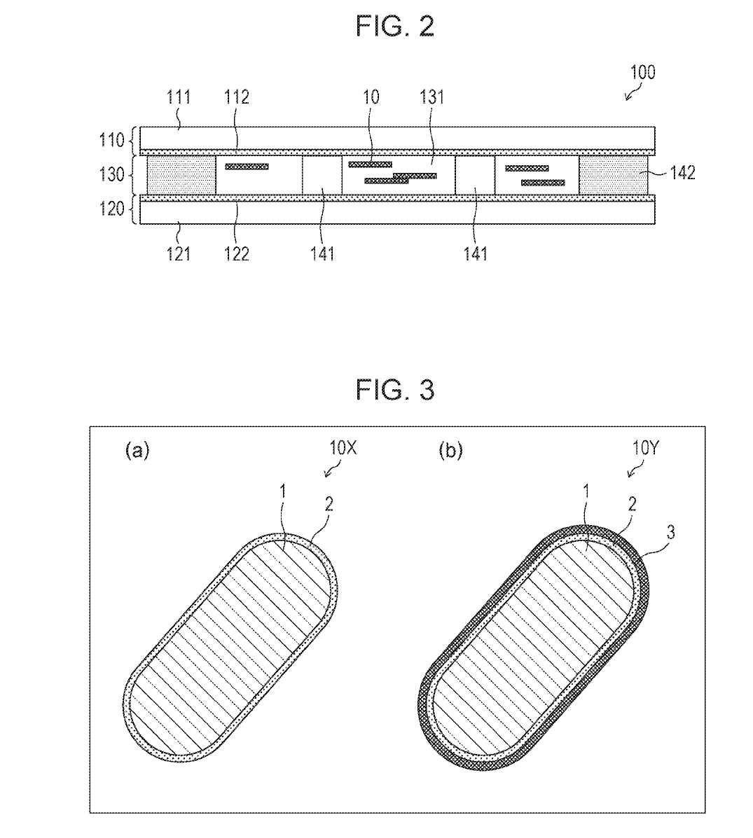

Hereinafter, Embodiment 1 of the present disclosure will be described in detail with reference to FIGS. 1 to 8. First, with reference to FIG. 2, an outline of a dimming device 100 of the present embodiment will be described. FIG. 2 is a view schematically illustrating an internal configuration of the dimming device 100.

In addition, in the present embodiment, a case where a first wavelength range and a second wavelength range which will be described later are different from each other (that is, at least part of the second wavelength range does not overlap the first wavelength range) is exemplified. However, as will be described later, the first wavelength range and the second wavelength range may be the same wavelength range.

### (Dimming Device 100)

The dimming device 100 adjusts a transmittance of light by controlling an orientation of a flake 10 (dimming member) (also called a light reflective material). The dimming device 100 includes a pair of substrates 110 and 120 disposed to oppose each other, and a light modulation layer 130 disposed between the substrates 110 and 120. In addition, the dimming device 100 further includes a power source 51 (refer to FIG. 1 which will be described later).

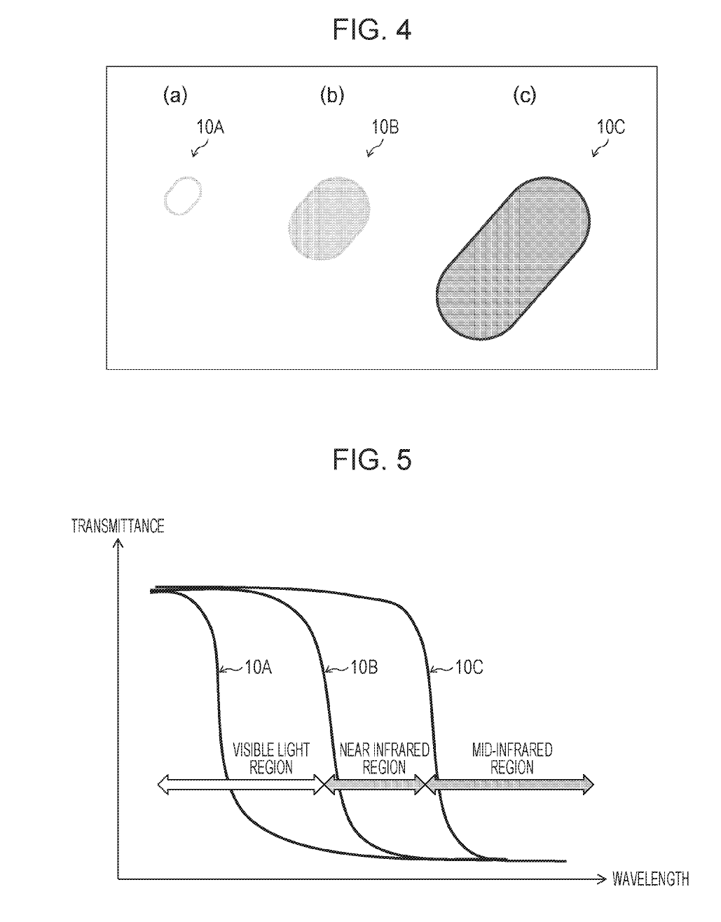

The flake 10 is a member for changing a transmittance of light in a predetermined wavelength range in accordance with a change in an orientation state. The flake 10 has a function of reflecting the light in the predetermined wavelength range, for example. As an example, by disposing the dimming device 100 including the flake 10 in a window, it is possible to adjust an amount of external light which is incident from outdoors to indoors. The flake 10 is a member which collectively represents flakes 10X to 10Y and flakes 10A to 10C which will be described later (refer to FIGS. 3 and 4). The description of the flakes will be described later.

The substrate 110 includes an insulating substrate 111 and an electrode 112. Similarly, the substrate 120 includes an insulating substrate 121 and an electrode 122. The insulating substrates 111 and 121 may be, for example, a transparent glass substrate. In addition, in a case where the insulating substrates 111 and 121 are glass substrates, in order to prevent thermal cracking, glass edges may be clean cut and may be chamfered by polishing or the like. In addition, a transparent plastic substrate may also be used as the insulating substrates 111 and 121. In addition, as the material of the insulating substrates 111 and 121, a material having relatively low light permeability, such as frosted glass, may also be used.

The electrodes 112 and 122 are transparent electrodes, and are, for example, formed of a transparent conductive film which adjusts an amount of carriers to be small and transmits near infrared light to a certain extent. For example, the electrodes 112 and 122 are formed of a material having a transmittance of the near infrared light with a wavelength of 1000 nm of 70% and a transmittance of the near infrared light with a wavelength of 1500 nm of 70% or more.

Specific examples of the electrodes 112 and 122 include titanium doped indium oxide (InTiO), tantalum substituted tin oxide with a seed layer of anatase type titanium dioxide, indium tin oxide (ITO), indium zinc oxide (IZO), zinc oxide, tin oxide and the like. In addition, the electrodes 112 and 122 are each connected to the power source 51 via a wiring 71 (refer to FIG. 1).

The power source 51 is a power source capable of applying a predetermined voltage (DC voltage or AC voltage) between the electrodes 112 and 122. By applying a voltage between the electrodes 112 and 122, it is possible to generate an electric field between the electrodes 112 and 122.

As will be described below, the flake 10 operates under influence of the electric field. In other words, by providing the power source 51, it is possible to control the orientation of the flake 10. In addition, the size (amplitude) and the frequency of the voltage supplied by the power source 51 may be controlled by a control unit 510 (refer to FIG. 12 and the like) which will be described later.

The substrate 110 and the substrate 120 adhere to each other by a sealing material 142 provided in a circumferential edge portion of the substrates 110 and 120. As the sealing material 142, for example, an ultra violet (UV) curable resin is preferably used. In addition, it is more desirable to form the sealing material having solvent resistance on an inner side that is in contact with a medium 131 which will be described later, and to further form a sealing material having a strong adhesive force on the outer side thereof, as the sealing material 142.

In addition, a spacer 141 is provided on a surface of one of the substrates 110 and 120 opposing the other substrate. The spacer 141 has, for example, a rectangular section, and is a resin spacer having a sectional area of 50 μm² and a height of 50 μm. By providing the spacer 141, the distance between the substrates 110 and 120 may be kept constant.

The light modulation layer 130 is a layer provided between the electrodes 112 and 122. The light modulation layer 130 includes the medium 131 and a plurality of flakes 10 dispersed in the medium 131. The medium 131 is a substance having fluidity.

In a case where the dimming device 100 is provided in a window (using the dimming device 100 as a smart window), it is preferable that the medium 131 is, for example, liquids which do not substantially perform absorption in a visible light region, or the liquids which are colored with a dye. In addition, it is preferable that the medium 131 has a higher relative dielectric constant (that is, dielectric constant) than that of the flake 10. As an example, it is preferable that the relative dielectric constant of the medium 131 is equal to or higher than 20.

In addition, in a case where a conductive film (for example, a conductive film 2 described below) is formed on the inside of the flake 10, the dielectric constant of the flake 10 is mainly regulated by the dielectric constant of an insulating film (for example, an insulating film 3 described below) positioned on the outer side of the conductive film. This is because electrostatic shielding occurs on the inside of the conductive film.

On the other hand, in a case where the conductive film is not formed on the inside of the flake 10, no electrostatic shielding occurs, and thus, the dielectric constant of the flake 10 is regulated by the dielectric constant of each insulating layer included in the flake 10.

Further, the medium 131 may be formed of a single substance or a mixture of a plurality of substances. As a material for forming the medium 131, for example, propylene carbonate, N-methyl-2-pyrrolidone (NMP), fluorocarbon, silicone oil or the like may be used.

In a case of manufacturing the dimming device 100, for example, propylene carbonate is used as the medium 131, and a dispersion (light reflective material mixture liquid) that disperses the flake 10 in the medium 131 at a rate of, for example, 6.5 wt % is prepared. In addition, the dispersion is dropped onto one of the substrates 110 and 120 on which the sealing material 142 is formed.

In addition, it is preferable that, for example, a UV-curable resin is formed as the sealing material 142 on the substrate onto which the dispersion is dropped. In addition, it is more preferable that the sealing material having solvent resistance is formed on the inner side which is in contact with the medium 131 and the sealing material having a strong adhesive force is formed on the outer side of the sealing material. In a state where the dispersion is dropped, after bonding the substrates 110 and 120 to each other, by curing the sealing material 142, it is possible to manufacture the dimming device 100.

As described below, the dimming device 100 has at least a function of dimming each of light beams including visible light and near infrared light. In view of this point, it is preferable that the materials of the substrates 110 and 120 and the medium 131 are substances having a low absorption rate of the visible light and the near infrared light.

The reason thereof is that, in a case where the materials of the substrates 110 and 120 or the medium 131 are substances having a high absorption rate of the visible light and the near infrared light, most of the visible light and the near infrared light are absorbed by the substrates 110 and 120 or the medium 131. Therefore, even in a case where the dimming device 100 is switched to an operation mode in which the visible light and the near infrared light are transmitted, the amount of the visible light and the near infrared light that are transmitted through the dimming device 100 decreases.

In addition, while the orientation state of the flake 10 may be held when viscosity of the medium 131 is high, there is a possibility that the voltage (referred to as a voltage supplied from the power source 51, and also referred to as a driving voltage) for changing the orientation state of the flake 10 increases. In a case where the dimming device 100 is provided in a window and the transmittance of the near infrared light incident from the window to indoors is adjusted, the number of times of operation is approximately several times a day.

Even when the driving voltage is high, in a case where the fact that it is possible to hold the orientation state of the flake 10 is advantageous for lowering the power consumption of the dimming device 100, it is possible to use a medium having high viscosity as the medium 131 in order to hold the orientation state of the flake 10.

In addition, in order to increase the viscosity of the medium 131, a medium having high viscosity when used alone, such as silicone oil or polyethylene glycol, may be used as the medium 131. Further, polymethyl methacrylate (PMMA) or the like may be mixed, or a material that exhibits thixotropy, such as fine silica particles, may be mixed into the medium 131.

In particular, in a case where thixotropy is imparted to the medium 131 by mixing the material that exhibits thixotropy into the medium 131, it is possible to suppress sedimentation of the flake 10, and to impart memory properties to an operating state of the dimming device 100. Therefore, by reducing the frequency of application of the driving voltage, the power consumption may be reduced.

### (Flakes 10X and 10Y)

Next, with reference to FIG. 3, a specific configuration of the flakes of the present embodiment will be described. FIGS. 3(a) and 3(b) are views each schematically illustrating an internal structure of the flake. In addition, in order to distinguish the flakes from the above-described flake 10, the flakes illustrated in FIGS. 3(a) and 3(b) are referred to as the flake 10X and the flakes 10Y, respectively.

As illustrated in FIG. 3(a), the flakes 10X includes a base 1 and the conductive film 2. The base 1 is a base material for depositing the conductive film 2 described below, and has transmission properties. The material of the base 1 may be a material having transmission properties. The material of the base 1 is, for example, glass, film, or resin. In addition, when the material of the base 1 is glass, it is easy to form the base 1 such that the size of the flake 10 has a preferable size (a long side is equal to or shorter than 50 μm and a thickness is equal to or less than 20 μm) which will be described later.

The conductive film 2 is a film (light reflection film) that is laminated on the surface of the base 1 and reflects light (for example, visible light, near infrared light, or mid-infrared light) having a specific wavelength. As an example, by using a metal material (Al, Cu, or the like) as the material of the conductive film 2, it is possible to form the conductive film 2 as a conductive film that reflects the visible light. In addition, by using ITO as the material of the conductive film 2, it is possible to form the conductive film 2 as a film that reflects the near infrared light.

However, as a material of the conductive film 2, it is possible to use any material as long as the material is a material that reflects the light having a specific wavelength. As the material of the conductive film 2, a transparent conductive film, such as zinc oxide, or a nanoparticle, such as Ag, may also be used. However, as described below, the material of the light reflection film is not limited to a conductive material. In other words, the light reflection film is not limited to the conductive film 2.

In addition, in a case where the conductive film 2 reflects the near infrared light, it is preferable that the conductive film 2 is a transparent film formed of a material having a transmittance of the visible light of 50% or more. In this case, when the dimming device 100 including the flake 10 is used as a window, 50% or more of the visible light is transmitted in any of a near infrared light transmission state and a near infrared light reflection state.

Examples of such a material include indium tin oxide, gallium-added zinc oxide, aluminum-added zinc oxide, InGaZnO-based oxide semiconductor, or a material obtained by adding an impurity to these materials.

In addition, as illustrated in FIG. 3(b), an insulating film may further be provided on the flake in addition to the base 1 and the conductive film 2. The flake 10Y of FIG. 3(b) is a flake obtained by further laminating the insulating film 3 on the surface of the conductive film 2 in the flake 10X.

The insulating film 3 is formed of a material having no conductivity. The material of the insulating film 3 is, for example, SiO₂. However, the material of the insulating film 3 is not limited to SiO₂, may be, for example, TiO₂, Al₂O₃, SiN, TiN, or the like, or may be a resin material, such as polyimide.

In other words, the material of the insulating film 3 is not particularly limited as long as the material is a material which is not dissolved or swelled by the medium 131. By providing the insulating film 3, it is possible to prevent aggregation of the flakes 10Y with each other on the inside of the dimming device 100. Therefore, even in a case where the operation mode of the dimming device 100 is switched multiple times, it is possible to prevent deterioration of dimming performance of the dimming device 100.

In addition, in the flakes 10X and 10Y, a buffer layer for improving adhesion of the conductive film 2 may further be provided between the base 1 and the conductive film 2. For example, in a case where the material of the base 1 is glass, a SiO₂ film may be formed as a buffer layer on the surface of the base 1, and the conductive film 2 may be formed on the buffer layer. In this case, compared to a case where the conductive film 2 is formed directly on the surface of the base 1 made of a glass material, a film having higher adhesion may be obtained.

In addition, it is preferable that the size of a long side of the flake 10 (that is, the flakes 10X and 10Y) is equal to or less than 50 μm and the size of a thickness is equal to or less than 20 μm. Here, the long side is the diameter of the smallest circle that encloses the flake 10 in a plan view.

When the long side and the thickness of the flake 10 are within the above-described ranges, since the mass of the flakes is small, it is easy to change the orientation state of the flakes. Therefore, the power consumption of the dimming device 100 may be reduced. In addition, when the thickness of the flake 10 is within the above-described range, in a case of shielding (reflecting) the light by the flake, the possibility that the flakes are oriented to be perpendicular to the substrates 110 and 120 is reduced (also refer to FIG. 1).

In addition, in the present embodiment, “shielding” means that the transmittance of the light is equal to or lower than a predetermined value. In other words, it should be noted that “shielding” does not always mean that the transmittance of the light is 0 (the light is completely blocked). More specifically, “shielding” is a collective expression that means not only “blocking of light” (in a case where the transmittance of the light is 0) but also “suppression (attenuation) of light” (in a case where the transmittance of the light is not 0).

In addition, even when the long side of the flake 10 is longer than 50 μm, for example, 100 μm, by applying a driving voltage, it is possible to operate the flake 10 (change the orientation of the flake 10). However, as the driving voltage is applied, the speed at which the orientation of the flake 10 changes becomes slow. In addition, in a case where the long side of the flake 10 is longer (for example, 200 μm), in order to change the orientation of the flake 10, a considerably high driving voltage is required. In addition, as the driving voltage increases, the Coulomb force that acts on the flakes 10 increases and the flakes 10 are likely to aggregate with each other.

### (Flakes 10A, 10B, and 10C)

Next, further variations of the flake of the present embodiment will be described with reference to FIGS. 4 and 5. FIGS. 4(a) to 4(c) are views each schematically illustrating an appearance of the flake.

In addition, FIG. 5 is a graph illustrating transmission characteristics of the light of each flake illustrated in FIGS. 4(a) to 4(c). More specifically, the graph of FIG. 5 illustrates the transmittance of the light in a case where the light is incident in a direction (normal direction of each flake) perpendicular to a long axis direction of each flake. In the graph of FIG. 5, the horizontal axis indicates the wavelength of the light and the vertical axis indicates the transmittance of the light.

In addition, in order to distinguish the above-described flakes 10, 10X, and 10Y from each other, the flakes illustrated in FIGS. 4(a) to 4(c) are referred to the flake 10A (first dimming member), the flake 10B (second dimming member), and the flake 10C (third dimming member), respectively.

As illustrated in FIGS. 4(a) to 4(c), the sizes of the flakes 10A to 10C are significantly different from each other. Specifically, the flake 10A is a small flake (the smallest flake), the flake 10B is a medium-sized flake, and the flake 10C is a large flake (the largest flake).

As an example, the size of a long side of the flake 10A is 20 μm and the size of a thickness is 5 μm. In addition, the size of a long side of the flake 10B is 25 μm and the size of a thickness is 10 μm. Further, the size of a long side of the flake 10C is 45 μm and the size of a thickness is 20 μm.

In addition, as illustrated in FIG. 5, the transmission characteristics of the light of the flakes 10A to 10C are significantly different from each other. In other words, in the configuration of FIG. 5, the first to the third dimming members are distinguished from each other depending on the difference in the size of the flakes.

Specifically, the flake 10A appropriately transmits the light in a predetermined wavelength range in the visible light region, and shields (reflects) the light in a wavelength band longer than the wavelength range. In addition, the flake 10B appropriately transmits the light in a predetermined wavelength range in the visible light region and in the near infrared region, and shields (reflects) the light in a wavelength band longer than the wavelength range. Further, the flake 10C appropriately transmits the light in a predetermined wavelength range in the visible light region, the near infrared region, and a mid-infrared region, and shields the light in a wavelength band longer than the wavelength range.

In addition, as illustrated in FIG. 5, in a case of imparting the transmission characteristics of the light different from each other to the flakes having different sizes, it is preferable to make the shapes of each of the flakes uniform. This is because, by making the shapes of each of the flakes uniform, it is possible to reduce variations in the driving voltage for changing the orientation state of each flake.

Further, in the flakes 10A to 10C, by changing each of the materials of the conductive film 2, the transmission characteristics of the light illustrated in FIG. 5 may be realized. For example, in the flake 10A, the material of the conductive film 2 is Al. In addition, in the flake 10B, the material of the conductive film 2 is ITO. Further, in the flake 10C, the material of the conductive film 2 is zinc oxide.

However, the graph of FIG. 5 illustrates an example of the transmission characteristics of the light of the flakes 10A to 10C, and the transmission characteristics of the light of the flakes 10A to 10C are not limited thereto. In the flakes 10A to 10C, by changing the material of the conductive film 2, the transmission characteristics of the light different from those of FIG. 5 may also be realized.

In addition, with reference to FIG. 5, it is ascertained that, in the flake that shields the light in a long wavelength region (for example, the near infrared region or the mid-infrared region), it is difficult to shield the light having a wavelength in a short wavelength region (for example, the visible light region).

In a general usage aspect of the dimming device 100, it is considered that the frequency of dimming the light (particularly, visible light) having a wavelength in the short wavelength region is high, and thus, it is preferable that the smallest flake 10A is formed as a flake for adjusting the transmittance of the visible light.

The reason thereof is that, as described below, the smallest flake 10A is the easiest to switch the orientation state of the flake. Therefore, by adjusting the transmittance of the visible light by the flake 10A, it is possible to reduce the power consumption of the dimming device 100 in the operation mode (mode for adjusting the transmittance of the visible light) assumed to have the highest frequency.

However, depending on the usage aspect of the dimming device 100, a case where the adjustment of the transmittance of the light in the long wavelength region is performed more frequently than the adjustment of the transmittance of the light (visible light) in the short wavelength region is also considered. In such a case, the smallest flake 10A may be formed as a flake for adjusting the transmittance of the light in the long wavelength region. In this case, the largest flake 10C may be formed as a flake for adjusting the transmittance of the visible light.

### (Specific Example of Dimming by Dimming Device 100)

Next, with reference to FIG. 1, a specific example of the dimming (adjustment of the transmittance of the light) by the dimming device 100 will be described. FIGS. 1(a) to 1(c) are views each illustrating specific examples of the dimming by the dimming device 100.

In addition, in FIG. 1, for simplicity, a case where two types of flakes including the flakes 10A and 10B are provided as flakes (flake 10 of FIG. 2) in the dimming device 100 is exemplified.

FIG. 1 illustrates an example where the transmittance of the light (external light) incident on the light modulation layer 130 from the substrate 110 side is adjusted. In addition, for the description, the light is illustrated while being distinguished into visible light L1 (light in the first wavelength range) and near infrared light L2 (light in the second wavelength range, infrared light).

Here, the first wavelength range is a wavelength range of the visible light L1, and is, for example, 380 nm to 780 nm. As described below, the flake 10A may change the transmittance of the visible light L1 in the first wavelength range in accordance with the change in the orientation state.

In addition, the second wavelength range is a wavelength range of the near infrared light L2, and is, for example, 900 nm to 2500 nm. As described below, the flake 10B may change the transmittance of the near infrared light L2 in the second wavelength range in accordance with the change in the orientation state.

In addition, the numerical values of the first wavelength range and the second wavelength range are mere examples and are not limited thereto. In addition, in the present embodiment, at least part of the second wavelength range does not overlap the first wavelength range. However, as described above, the first wavelength range and the second wavelength range may be the same wavelength range.

In addition, for example, when the wavelength range of mid-infrared light is a third wavelength range, at least part of the third wavelength range does not overlap the first wavelength range and the second wavelength range. However, at least two of the first wavelength range to the third wavelength range may be the same wavelength range.

### (First State)

First, as illustrated in FIG. 1(a), a case where a DC voltage (frequency=0 Hz) of 2 V, for example, is applied between the electrodes 112 and 122 by the power source 51. In this case, negatively charged flakes 10A and 10B gather in the vicinity of one electrode (for example, electrode 112) by electrophoresis. In addition, the flakes 10A and 10B are oriented such that long axes thereof are parallel to the substrates 110 and 120.

As a result, a dimming state where both the visible light L1 and the near infrared light L2 are shielded is obtained. Hereinafter, the dimming state is also referred to as a first state. In addition, in the first state, between the electrodes 112 and 122, instead of a DC voltage, for example, by applying an AC voltage having a low frequency of, for example, 1 Hz or less, so-called image sticking may be avoided.

In addition, in FIG. 1(a), an example in which the flakes 10A and 10B stick to the electrode 112 in a case where a positive electrode of the power source 51 is connected to the electrode 112 and a negative electrode of the power source 51 is connected to the electrode 122 is illustrated.

However, an aspect of connection between the electrodes 112 and 122 and the power source 51 is not limited thereto. For example, the negative electrode of the power source 51 may be connected to the electrode 112, and the positive electrode of the power source 51 may be connected to the electrode 122. In this case, the negatively charged flakes 10A and 10B stick to the electrode 122.

Further, by changing the material (particularly, the material of the insulating film 3) of the flakes 10A and 10B, the polarity of the charges carried by the flakes 10A and 10B may also be changed. For example, the flakes 10A and 10B may be positively charged. In this case, in the configuration of FIG. 1(a), the flakes 10A and 10B stick to the electrode 122.

As described above, in a case where the DC voltage or the AC voltage having a low frequency of 1 Hz or less is applied between the electrodes 112 and 122, by a force described as the electrophoretic force or the Coulomb force, the charged flakes 10A and 10B are attracted to the vicinity of the electrode to which a voltage having a polarity reversed to the polarity of the electric charge charged by the flakes 10A and 10B is applied.

In addition, the flakes 10A and 10B take the most stable orientation and rotate so as to stick to the substrate 110 or the substrate 120. In other words, the flakes 10A and 10B are oriented such that long axes thereof are parallel to the substrates 110 and 120. As a result, the visible light L1 and the near infrared light L2 which are light incident on the light modulation layer 130 from the substrate 110 side, are shielded by the flakes 10A and 10B, and the transmittance of the light modulation layer 130 decreases.

### (Second State)

Next, a case where an AC voltage having a sufficiently higher frequency than that of a case of FIG. 1(a) is applied between the electrodes 112 and 122 by the power source 51, is considered. For example, a case where an AC voltage having a frequency of 60 Hz (predetermined frequency, first frequency) and an amplitude of 2 V (first amplitude) is applied between the electrodes 112 and 122, is considered.

In this case, as illustrated in FIG. 1(b), by the force (hereinafter, referred to as an orientation changing force) described from the viewpoint of the dielectrophoretic phenomenon, the Coulomb force, or the electric energy, the smallest flake 10A (a flake having the smallest mass and a flake in which the orientation state is the most likely to change) rotates in a direction perpendicular to the substrates 110 and 120. In other words, the flake 10A rotates such that the long axis thereof is parallel to the line of electric force.

In other words, the orientation of the flake 10A changes such that the long axis thereof is perpendicular to the substrates 110 and 120. As a result, the visible light L1 incident on the light modulation layer 130 from the substrate 110 side transmits the light modulation layer 130 and is emitted from the substrate 120 side.

On the other hand, even in a case where an AC voltage having a frequency of 60 Hz and an amplitude of 2 V is applied, the orientation state of the flake 10B does not change from the state of FIG. 1(a). This is because the flake 10B is a flake (flake having a greater mass) greater than the flake 10A and the orientation state thereof is unlikely to change compared to the flake 10A.

Therefore, the near infrared light L2 incident on the light modulation layer 130 from the substrate 110 side is shielded by the flake 10B, and the transmittance of the light modulation layer 130 decreases. Therefore, in a case of FIG. 1(b), the dimming state where the visible light L1 is transmitted and the near infrared light L2 is shielded is obtained. Hereinafter, the dimming state is also referred to as a second state.

In addition, the above-described orientation changing force depends not only on the amplitude of the AC voltage but also on the frequency. The predetermined frequency of 60 Hz is set as a frequency at which the orientation state of the flakes may be changed by the orientation changing force.

For example, even in a case where the amplitude of the AC voltage is 2 V, in a case where the frequency is set to a low frequency (for example, approximately 0.1 Hz), it is not possible to change the orientation of the flake 10A (the smallest flake) by orientation changing force. In addition, even in a case where the frequency is set to a high frequency (for example, approximately 1 MHz), it is not possible to change the orientation of the flake 10A by the orientation changing force. In this manner, the predetermined frequency range is limited to a specific frequency band to a certain extent.

### (Third State)

Next, a case where an AC voltage having a greater amplitude than that of a case of FIG. 1(b) is applied between the electrodes 112 and 122 by the power source 51, is considered. For example, a case where an AC voltage having a frequency of 60 Hz (predetermined frequency, second frequency) and an amplitude of 5 V (second amplitude) is applied between the electrodes 112 and 122, is considered.

In this case, the above-described orientation changing force increases more than that in a case of FIG. 1(b). Therefore, as illustrated in FIG. 1(c), the greater flake 10B also rotates in the direction perpendicular to the substrates 110 and 120. In other words, the orientation state of the flake 10B may also be changed. Therefore, the near infrared light L2 incident on the light modulation layer 130 from the substrate 110 side is shielded by the flake 10B, and the transmittance of the light modulation layer 130 decreases.

In addition, similar to a case of FIG. 1(b), the flake 10A maintains the orientation state of being perpendicular to the substrates 110 and 120. Therefore, in a case of FIG. 1(c), the dimming state where both the visible light L1 and the near infrared light L2 are transmitted is obtained. Hereinafter, the dimming state is also referred to as a third state.

As described above, according to the dimming device 100, it is possible to switch between three dimming states (operation modes) of the first state to the third state. Therefore, it is possible to adjust the transmittance for each of light beams (the visible light L1 and the near infrared light L2) of the two types of wavelength bands.

In addition, the frequency at which the orientation state of the flakes 10A and 10B changes is preset depending on the shape and the material of the flakes 10A and 10B, the thickness of the light modulation layer 130, and the like. Therefore, the frequency (the first frequency and the second frequency) and the amplitude (the first amplitude and the second amplitude) of the voltage for realizing the first state and the second state may also set in accordance with the shape and the material of the flakes 10A and 10B, the thickness of the light modulation layer 130, and the like.

In addition, in the description above, a case where the second amplitude is greater than the first amplitude is exemplified, but the second amplitude may be the same as the first amplitude. In other words, the second amplitude may be equal to or greater than the first amplitude.

In addition, in the description above, a case where the frequency (second frequency) (hereinafter, referred to as a frequency f2) of the AC voltage in the third state is the same frequency (first frequency) (hereinafter, referred to as a frequency f1) of the AC voltage in the second state, is exemplified. However, the frequency f2 is not necessarily the same as the frequency f1.

However, in a case where the frequency f2 is the same as the frequency f1, the configuration of the power source 51 may be simplified. In addition, in a case where the frequency f2 is the same as the frequency f1, the first frequency and the second frequency are collectively referred to as a predetermined frequency.

In addition, in a case where the frequency f2 is the same as the frequency f1, even in a case where the frequency f2 slightly deviates from the frequency f1, the frequency f2 may be regarded as the same (more specifically, substantially the same) as f1 as long as the frequency is in a range that does not particularly influence the operation of the dimming device 100.

For example, even in a case where f1=60 Hz and f2=60.1 Hz (or f2=59.9 Hz), the frequency f2 may be regarded as the same as the frequency f1. In addition, the numerical value of the above-described frequency is an example, and the range of frequency in which f2 may be regarded as the same as f1 varies depending on the specification of the dimming device 100. For example, depending on the specification of the dimming device 100, even in a case where f1=60 Hz and f2=61 Hz (or f2=59 Hz), it may be regarded that f2 is the same as f1. This also applies to the N-th state (N is an integer of 2 or more) described below.

In addition, in the description above, although the frequency of 60 Hz is exemplified as an example of f1 and f2, the values of f1 and f2 may be appropriately set in accordance with the specification of the dimming device 100, and are not limited thereto. For example, the values of f1 and f2 may be 50 Hz or may be 100 Hz.

### (Another Example of Dimming by Dimming Device 100)

In FIG. 1 described above, for simplicity, a case where two types of flakes including the flakes 10A and 10B are provided in the dimming device 100 is exemplified. However, in the dimming device 100, the flake 10C (the largest flake, a flake for adjusting the transmittance of the mid-infrared light) may further be provided. As described below, the flake 10C may change the transmittance of the mid-infrared light in the third wavelength range in accordance with the change in the orientation state.

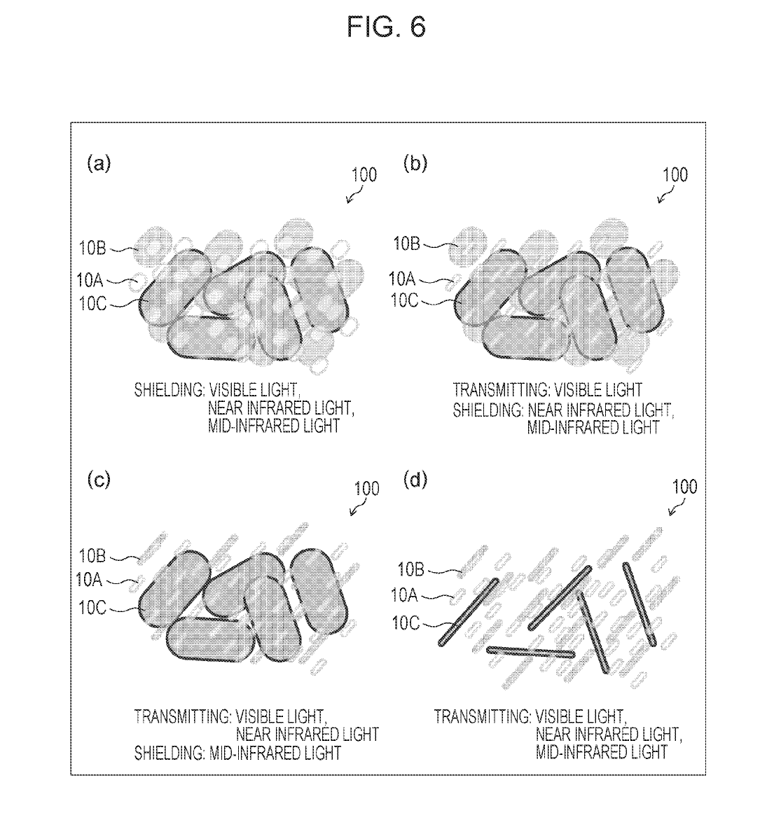

FIGS. 6(a) to 6(d) are views each illustrating specific examples of the dimming in a case where three types of flakes including the flakes 10A to 10C are provided in the dimming device 100. In addition, in FIG. 6, for simplicity, members other than the flakes 10A to 10C are omitted.

FIG. 6(a) illustrates a state (first state) where the flakes 10A to 10C are oriented to be parallel with the substrates 110 and 120 by applying a DC voltage having 2 V, for example, between the substrates 110 and 120. In the first state, any of the visible light, the near infrared light, and the mid-infrared light is shielded.

FIG. 6(b) illustrates a state (second state) where (i) the flake 10A is oriented to be perpendicular to the substrates 110 and 120 and (ii) the flakes 10B and 10C are oriented to be parallel to the substrates 110 and 120, by applying the AC voltage having a frequency of 60 Hz (first frequency, predetermined frequency) and an amplitude of 2 V (first amplitude) between the substrates 110 and 120. In the second state, the visible light is transmitted and the near infrared light and the mid-infrared light are shielded.

FIG. 6(c) illustrates a state (third state) where (i) the flakes 10A and 10B are oriented to be perpendicular to the substrates 110 and 120 and (ii) the flake 10C is oriented to be parallel to the substrates 110 and 120, by applying the AC voltage having a frequency of 60 Hz (second frequency, predetermined frequency) and an amplitude of 5 V (second amplitude, amplitude equal to or greater than the first amplitude) between the substrates 110 and 120. In the third state, the visible light and the near infrared light are transmitted and the mid-infrared light is shielded.

FIG. 6(d) illustrates a state (fourth state) where (i) the flakes 10A to 10C are oriented to be parallel to the substrates 110 and 120, by applying the AC voltage having a frequency of 60 Hz (third frequency, predetermined frequency) and an amplitude of 8 V (third amplitude, amplitude equal to or greater than the second amplitude) between the substrates 110 and 120. In the fourth state, any of the visible light, the near infrared light, and the mid-infrared light is transmitted.

As described above, according to the dimming device 100, by switching four dimming states including the first to the fourth states, it is also possible to adjust the transmittance of each of light beams (visible light, near infrared light, and mid-infrared light) of three types of wavelength bands.

Further, in the dimming device 100, it is possible to switch more dimming states by providing more types of flakes. As described above, according to the dimming device 100, by providing N types (N is an integer of 2 or more) of flakes and utilizing the AC voltages having N amplitudes and N frequencies, it is possible to adjust the transmittance of the light by multiple operation modes (dimming modes), which could not be realized in the related art. In addition, the configurations of FIGS. 1 and 6 correspond to either one of N=2 and N=3.

In other words, the dimming device may be provided with a k-th dimming member that adjusts the transmittance of the light in a k-th (k is an integer that satisfies 1 k N) wavelength range in accordance with the change in the orientation state. In a case where an AC voltage having N frequencies and an amplitude equal to or greater than the k-th amplitude is applied, the k-th dimming member sets the transmittance of the light in the k-th wavelength range to be higher than that in a case where the k-th dimming member is oriented in the direction of shielding the light. Here, the (k+1)-th amplitude is equal to or greater than the k-th amplitude. In addition, the wavelength ranges from the first wavelength range to the (k+1)-th wavelength range may be different from each other. In addition, at least two wavelength ranges from the first wavelength range to the (k+1) wavelength range may be the same as each other.

### (Example of Manufacturing Method of Flake)

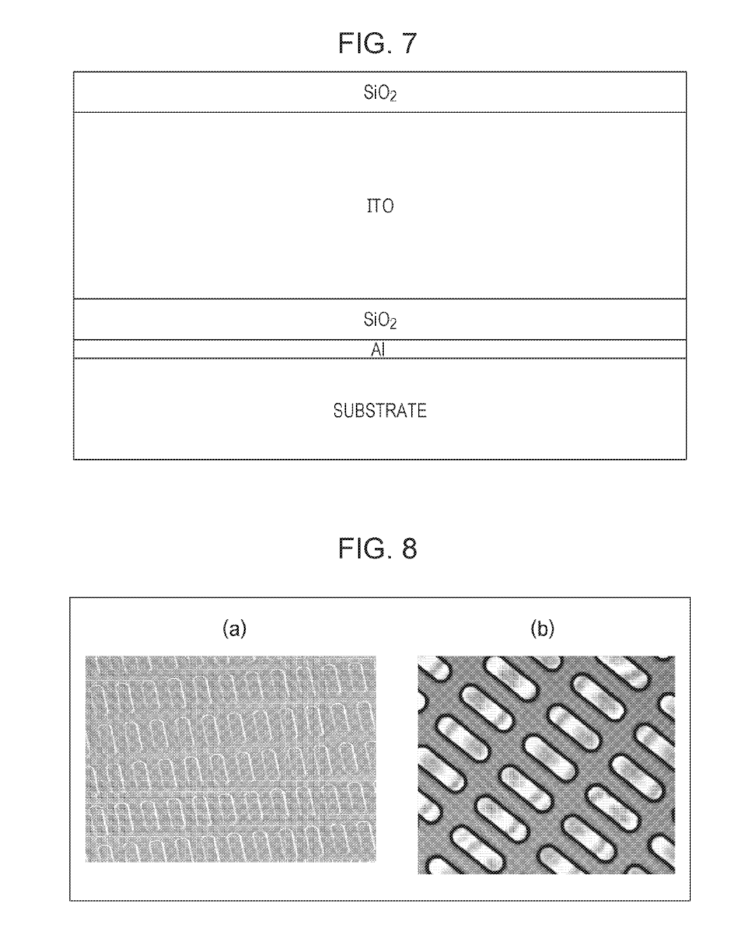

FIG. 7 is a view illustrating an example of a manufacturing method of the flake in the dimming device 100. FIG. 7 illustrates a configuration in a state where a film formation step described below is completed. Hereinafter, the description will be made by exemplifying a case where the flake (second dimming member) for adjusting the transmittance of the near infrared light is manufactured using a DC magnetron sputtering apparatus having a vacuum chamber.

In addition, in the DC magnetron sputtering apparatus, each of a plurality of types of targets which is a film forming material is fixed (set) in the vacuum chamber, and a target fixing unit capable of switching the target used for the film formation is provided.

### (Film Formation Step)

First, as the target, (i) Al target, (i) Si target, and (iii) ITO (ITO target) containing SnO₂ of 5% were each fixed to the target fixing unit. Next, a substrate (wafer, glass plate or the like) was placed in the vacuum chamber. The substrate corresponds to the above-described base 1.

Next, the inside of the vacuum chamber was evacuated (reduced pressure) to 5×10⁻⁴ Pa using a turbo molecular pump. Ar gas was introduced into the vacuum chamber after the evacuation at a flow rate of 200 sccm, and the pressure on the inside of the vacuum chamber was adjusted to 0.5 Pa. In this state, an electric power of 0.3 kW was applied to the Al target and an Al thin film (Al layer) having a predetermined thickness is formed.

Next, Ar gas was introduced at a flow rate of 160 sccm and O₂ gas was introduced at a flow rate of 40 sccm as a mixed gas, and the pressure on the inside of the vacuum chamber was adjusted to 0.5 Pa. In this state, an electric power of 1 kW was applied to the Si target, and a SiO₂ thin film (SiO₂ layer) having a predetermined thickness was formed on the Al layer. The SiO₂ layer corresponds to the above-described buffer layer and is also referred to as an underlayer.

After this, the substrate was heated and the temperature of the substrate was maintained at 150° C. Then, Ar gas was introduced at a flow rate of 198 sccm and O₂ gas was introduced at a flow rate of 2 sccm as a mixed gas into the vacuum chamber, and the pressure on the inside of the vacuum chamber was adjusted to 0.5 Pa. In this state, an electric power of 1 kW was applied to the ITO target, and an ITO thin film (ITO layer) having a predetermined thickness was formed on the SiO₂ layer (underlayer). The ITO thin film corresponds to the above-described conductive film 2.

Next, Ar gas was introduced at a flow rate of 160 sccm and O₂ gas was introduced at a flow rate of 4 sccm as a mixed gas into the vacuum chamber, and the pressure on the inside of the vacuum chamber was adjusted to 0.5 Pa. In this state, an electric power of 1 kW was applied to the Si target, and a SiO₂ thin film (SiO₂ layer) having a predetermined thickness was formed on the ITO layer (conductive film). The SiO₂ layer corresponds to the above-described insulating film 3.

Through the above-described film formation step, an Al layer, a SiO₂ layer (buffer layer), an ITO layer (conductive film), and a SiO₂ layer (insulating film) were sequentially formed (laminated) on the base.

### (Following Step)

Next, a photomask having a film thickness capable of withstanding dry etching was formed on the SiO₂ thin film which is an insulating film, and a sacrificing layer was formed using the photomask. In addition, a preliminary sacrificing layer may be formed on the SiO₂ thin film, and a sacrificing layer may be additionally formed on the preliminary sacrificing layer.

In addition, dry etching was performed using a chlorine-based gas or an iodine-based gas, and the base and each layer laminated on the base are formed in a predetermined shape (desired shape of a flake). After this, the Al layer is removed by an etchant (for example, an alkaline solution or an iron chloride-based acidic solution).

In addition, by peeling off the bottom portion of the base from the substrate, the flakes in which the SiO₂ layer (buffer layer), the ITO layer (conductive film), and the SiO₂ layer (insulating film) are formed on the base in order may be collected (obtained). In addition, an additional protection film (for example, oxide film, nitride film) may be additionally provided on the surface of the flake.

In addition, FIG. 8(a) is a scanning electron microscope (SEM) image of the substrate after the dry etching in the above-described manufacturing method. According to FIG. 8(a), it is understood that the base and each layer laminated on the base are formed in the desired shape of the flake. In addition, FIG. 8(b) is a micrograph of the substrate after peeling off the bottom portion of the base from the substrate in the above-described manufacturing method.

### (Effect of Dimming Device 100)

As described above, in the dimming device 100 according to the present embodiment, the first dimming member (flake 10A) for adjusting the transmittance of the light (for example, visible light L1) in the first wavelength range in accordance with the change in the orientation state, and a second dimming member (flake 10B) for adjusting the transmittance of the light (for example, near infrared light) in the second wavelength range in accordance with the change in the orientation state are provided.

In addition, as illustrated in FIG. 1 described above, in a case where the AC voltage having a first frequency (for example, 60 Hz) and an amplitude equal to or greater than the first amplitude (for example, 2 V) is applied, the transmittance of the light in the first wavelength range becomes higher than that in a case where the first dimming member is oriented in the direction of shielding the light. In addition, in a case where the AC voltage having a second frequency (for example, 60 Hz) and an amplitude equal to or greater than the second amplitude (for example, 5 V, amplitude equal to or greater than the first amplitude) is applied, the transmittance of the light in the second wavelength range becomes higher than that in a case where the second dimming member is oriented in the direction of shielding the light.

Therefore, for example, by gradually adjusting the amplitude of the AC voltage (for example, 2 V→5 V), the orientation state of the first dimming member and second dimming member (that is, the transmittance characteristics of the light in the first wavelength range and the light in the second wavelength range) may be individually controlled. Therefore, it is possible to adjust (perform dimming) the transmittance of the light by more various operation modes compared to the related art. In addition, when at least part of the second wavelength range does not overlap the first wavelength range, it is also possible to adjust the transmittance for each of light beams in the plurality of wavelength bands.

In addition, in the dimming device 100, the third dimming member (flake 10C) that adjusts the transmittance of the light (mid-infrared light) in the third wavelength range in accordance with the change in the orientation state, may further be provided. Accordingly, in a case where the AC voltage having the predetermined frequency and an amplitude equal to or greater than the third amplitude (for example, 8 V, amplitude equal to or greater than the second amplitude) is applied, the transmittance of the light in the third wavelength range becomes higher than that in a case where the third dimming member is oriented in the direction of shielding the light.

Further, according to the dimming device 100, it is also possible to control a solar radiation heat acquisition rate. This point will be described below. Considering that most of the infrared light emitted from the sun is the near infrared light, it may be said that controlling the solar radiation heat acquisition rate is substantially synonymous with adjusting the transmittance of the near infrared light. In addition, in winter, it is necessary to prevent the infrared light from being emitted from indoors to outdoors. In addition, the wavelength of the infrared light at this time is approximately 10 μm, and the infrared light is classified as the far-infrared light.

Here, it is preferable that the electrodes 112 and 122 which are transparent conductive films that transmit the near infrared light, are formed to have characteristics of reflecting the far-infrared light. In this case, the dimming device 100 may always reflect the far-infrared light. In other words, in a case where the operation mode of the dimming device 100 is controlled so as to take the near infrared light from outdoors in winter, it is possible to prevent indoor heat from escaping from indoors by radiant heat. Therefore, it is possible to prevent the indoor temperature from being lowered.

In addition, even in a case where the operation mode of the dimming device 100 is controlled such that the near infrared light does not enter from outdoors to indoors in summer, it is possible to prevent the far-infrared light from entering from outdoors to indoors at the same time as the near infrared light. Therefore, it is possible to prevent the indoor temperature from being raised.

In addition, in the description of the flake of the present embodiment, the configuration in which the conductive film 2 reflects the light having a specific wavelength as the light reflection film (light shielding film) is exemplified, but the light shielding film is not limited only to the conductive film 2. In other words, the light shielding film that reflects or absorbs the light having a specific wavelength may be provided on the surface of the base 1. The light shielding film (i) may be a multilayer film, (ii) may be a film formed of a pigment (inorganic pigment or organic pigment), glass containing the pigment, resin, polymer or the like, or (iii) may be a film that forms Ag nanoparticles or ITO nanoparticles in a film shape.

In addition, in the flake according to one aspect of the present disclosure, the base 1 may be made of a material (light shielding material) that reflects or absorbs the light having a specific wavelength. In this case, as the light shielding material, the same material as that of the above-described light shielding film may be used.

Further, the base is not in the shape of the flake, but may be a needle crystal. In this case, the dimming device 100 is a suspended particle device (SPD) that switches the absorption rate of the external light by rotating the needle-shaped dimming member with a voltage and switching the orientation state of the needle crystal to a random state and a state parallel to the electric field.

### Modification Example

In the above-described Embodiment 1, the first dimming member and the second dimming member are realized depending on the difference in the size of the flakes. However, as described in the following (1) to (3), even in a case where the sizes of the flakes are approximately the same as each other, it is possible to realize each of members including the first dimming member and the second dimming member.

(1) For example, the influence of the above-described orientation changing force on the flake changes in accordance with the absolute value of the difference in the dielectric constant between the medium 131 around the flake and the flake. Specifically, as the absolute value increases, the influence of the orientation changing force on the flake increases. Therefore, in accordance with the dielectric constant of the flake, the degree of the influence of the orientation changing force on the change in the orientation of the flake may be changed.

Therefore, it is possible to make the flakes having dielectric constants different from each other each function as the first dimming member and the second dimming member. In other words, it is also possible to realize the first dimming member and the second dimming member by the difference in the dielectric constant of the flake.

For example, it is possible to make (i) a flake formed of a material having a greater absolute value of the difference in the dielectric constant with the medium 131 function as the first dimming member (a flake which is likely to be influenced by the orientation changing force), and (ii) a flake formed of a material having a smaller absolute value of the difference in the dielectric constant with the medium 131 function as the second dimming member (a flake which is unlikely to be influenced by the orientation changing force).

In other words, the absolute value (first absolute value) of the difference between the dielectric constant of the first dimming member and the dielectric constant of the medium 131 may be set to be greater than the absolute value (second absolute value) of the difference between the dielectric constant of the second dimming member and the dielectric constant of the medium 131.

(2) In addition, it is also possible to make the flakes having densities different from each other each function as the first dimming member and the second dimming member. Since the mass per unit volume of the flake having a low density is lower, the orientation is likely to change by the orientation changing force.

Therefore, it is possible to make (i) a flake having a lower density function as the first dimming member, and (ii) a flake having a higher density function as the second dimming member. In this manner, it is also possible to realize the first dimming member and the second dimming member by the difference in the density of the flake.

(3) In addition, it is also possible to make the flakes having anisotropies different from each other each function as the first dimming member and the second dimming member. In other words, it is also possible to realize the first dimming member and the second dimming member by the difference in the anisotropy of the flake. Here, it is understood that the anisotropy of the flake means an aspect ratio (a value of a ratio of the thickness to the width) of the flake.

In general, in the flakes, it is known that (i) it is difficult to change the orientation as the anisotropy decreases (for example, substantially spherical shape, substantially cubic shape), and (ii) it is likely to change the orientation by being influenced by the external force (for example, orientation changing force) as the anisotropy increases.

Therefore, it is also possible to make (i) a flake having a higher anisotropy function as the first dimming member, and (ii) a flake having a lower anisotropy as the second dimming member, respectively.

(4) In addition, as described above, the frequency at which the orientation state of the flake changes may be changed, for example, by changing the material of the flake. Therefore, the first dimming member and the second dimming member may be manufactured such that the frequency (first frequency) at which the orientation state of the first dimming member changes is different from the frequency (second frequency) at which the orientation state of the second dimming member changes. In this manner, by making the frequency at which the orientation state of the flake changes different, it is also possible to realize the first dimming member and the second dimming member.

### Modification Example

In addition, in the above-described Embodiment 1, a case where the first wavelength range is different from the second wavelength range has been exemplified. However, the first wavelength range and the second wavelength range may be the same wavelength range.

As an example, in a case where the first dimming member and the second dimming member are formed of the same material and the sizes of each dimming member are made different, the first wavelength range and the second wavelength range may be the same wavelength range.

In such a case, the transmittance of the light in the same wavelength range (predetermined wavelength range) may be gradually adjusted by each of the first dimming member and the second dimming member. For example, in a case where the orientation state of only the first dimming member is changed, the transmittance of the light in the dimming device may be set to 40% (first transmittance). In addition to the first dimming member, in a case where the orientation state of the second dimming member is changed, the transmittance of the light in the dimming device may be set to 80% (second transmittance).

In this manner, according to the dimming device according to one aspect of the present disclosure, even when the first wavelength range and the second wavelength range are the same wavelength range, it is possible to adjust the transmission of the light by more various operation modes compared to the related art.

### Embodiment 2

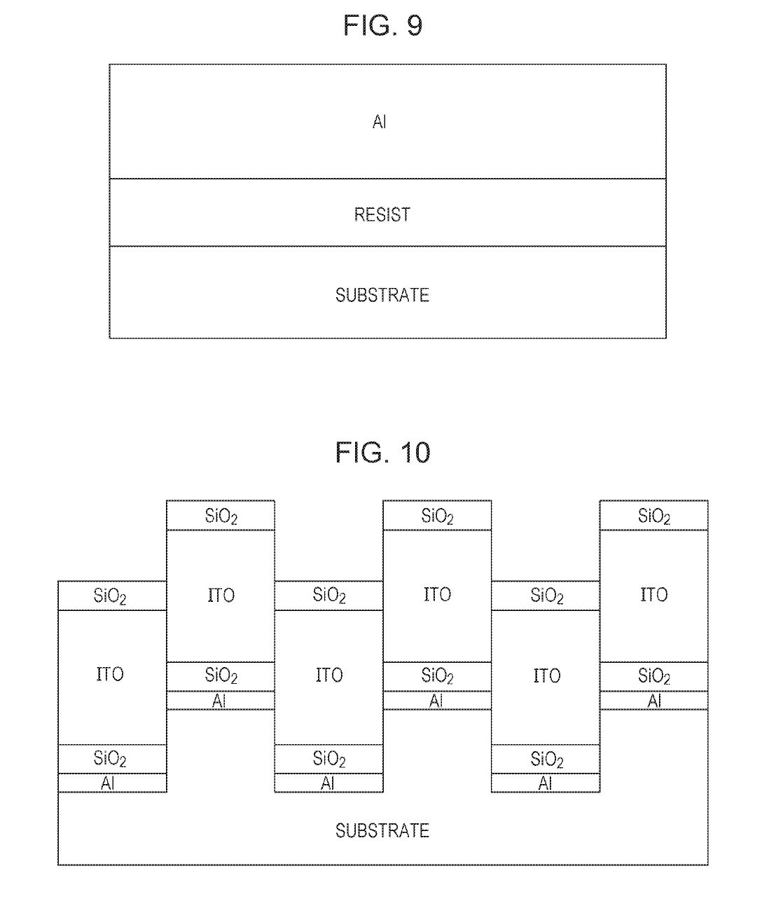

Embodiment 2 of the present disclosure will be described with reference to FIG. 9 as follows. In addition, for the convenience of description, members having the same functions as those of the members described in the above-described embodiment will be given the same reference symbols, and the description thereof will be omitted. In the above-described Embodiment 1, the manufacturing method of the flake that serves as the second dimming member is exemplified, but in the present embodiment, an example of the manufacturing method of the flake that serves as the first dimming member will be described.

FIG. 9 is a view illustrating another example of the manufacturing method of the flake in the dimming device 100. FIG. 9 illustrates a configuration in a state where the film formation step described below is completed. Hereinafter, the description will be made by exemplifying a case where the flake (first dimming member) for adjusting the transmittance of the visible light is manufactured using the above-described DC magnetron sputtering apparatus.

### (Film Formation Step)

First, the substrate similar to that in the above-described Embodiment 1 was spin-coated with a resist (also referred to as a lift-off material), and the substrate after the spin coating was baked in an oven. In addition, the Al target was fixed to the target fixing unit as the target. Next, the substrate after the baking was completed was taken out from the oven, and the substrate was placed in the vacuum chamber.

Next, the inside of the vacuum chamber was evacuated to 5×10⁻⁴ Pa using a turbo molecular pump. Ar gas was introduced into the vacuum chamber after the evacuation at a flow rate of 200 sccm, and the pressure on the inside of the vacuum chamber was adjusted to 0.5 Pa. In this state, an electric power of 0.3 kW was applied to the Al target to form an Al thin film (Al layer) having a predetermined thickness. The Al layer plays a role as the above-described conductive film 2.

Through the above-described film formation step, the resist and the Al layer (conductive film) were sequentially formed (laminated) on the base. In addition, the material of the resist may be changed in accordance with the material of the conductive film.

### (Following Step)

Next, a photomask having a film thickness capable of withstanding dry etching was formed on the Al layer which is a conductive film, and a sacrificing layer was formed using the photomask. In addition, dry etching was performed using a chlorine-based gas, and the base and each layer laminated on the base are formed in a predetermined shape (desired shape of the flake). After this, the resist layer was removed by acetone or the like.

In addition, by peeling off the bottom portion of the base from the substrate, the flakes in which the Al layer (conductive film) is formed on the base in order may be collected (obtained). In addition, as described above, an additional protection film (for example, oxide film, nitride film) may be additionally provided on the surface of the flake. In addition, since the upper surface of the flake is formed of metal (Al), the flakes may be protected by oxidizing the upper surface.

### Embodiment 3

Embodiment 3 of the present disclosure will be described with reference to FIG. 10 as follows. In the present embodiment, an example of a method for manufacturing the flake that serves as the second dimming member by a method different from that in the above-described Embodiment 1 will be described.

FIG. 10 is a view illustrating still another example of the manufacturing method of the flake in the dimming device 100. FIG. 10 illustrates a configuration in a state where the above-described film formation step is completed. The manufacturing method of the present embodiment is different from the manufacturing method of Embodiment 1 in that a patterned substrate is used.

In the manufacturing method of the present embodiment, first, a substrate is coated with a resist, and then, the substrate is exposed by a photomask. In addition, a plurality of recess portions and projection portions are formed on the substrate by dry etching. In addition, the shapes of the recess portion and the projected portion are formed so as to correspond to the desired shape of the flake.

Next, in each of portions including the recess portion and the projection portion of the substrate, a similar film formation to that in Embodiment 1 is performed. According to the manufacturing method of the present embodiment, a step of performing dry etching after the film formation and forming the base and each layer laminated on the base in the desired shape of the flake, is not necessary.

Therefore, since the flakes may be collected only by peeling off the bottom portion of the base from the substrate after the film formation, the flake may be manufactured more efficiently. In addition, it is also possible to reduce the manufacturing cost of the flake by repeatedly using the substrate on which the recess portion and the projection portion are formed.

### Embodiment 4

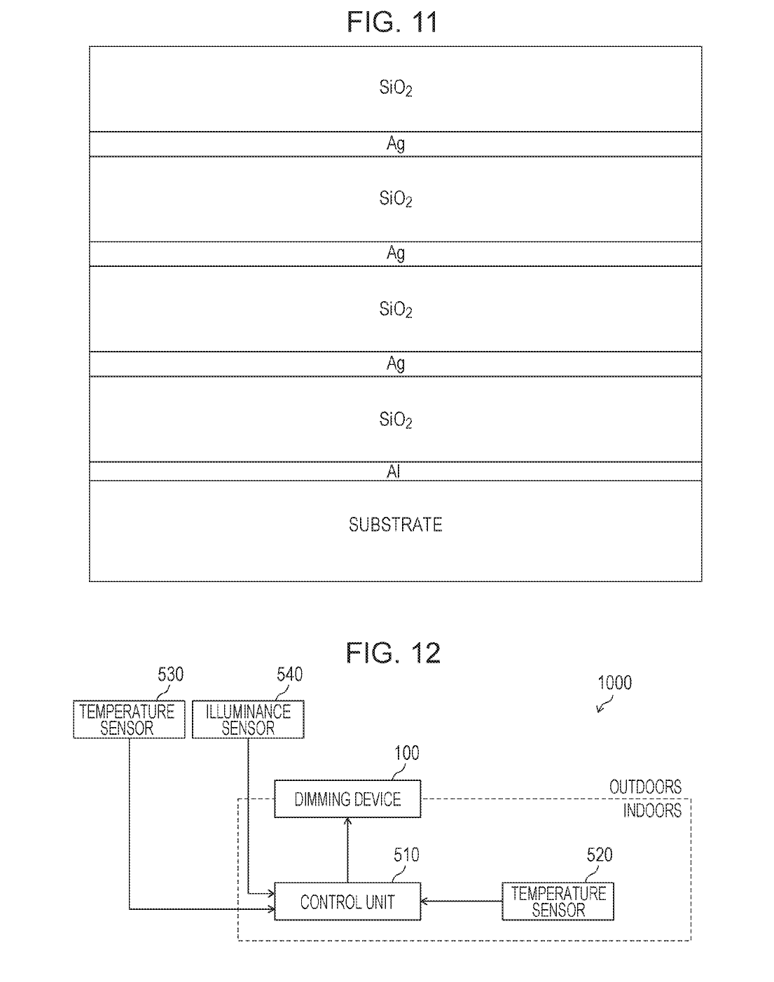

Embodiment 4 of the present disclosure will be described with reference to FIG. 11 as follows. In the present embodiment, an example of a method for manufacturing the flake that serves as the second dimming member by a method different from that in the above-described Embodiments 1 to 3 will be described.

FIG. 11 is a view illustrating still another example of the manufacturing method of the flake in the dimming device 100. FIG. 11 illustrates a configuration in a state where the above-described film formation step is completed. The manufacturing method of the present embodiment is different from the manufacturing methods of Embodiments 1 and 3 in that the flake is manufactured by a repeating structure.

The manufacturing method of the present embodiment is similar to the manufacturing method of Embodiment 1 until the Al layer is formed on the substrate. However, in the manufacturing method of the present embodiment, a SiO₂ layer (buffer layer, insulating film) having a predetermined thickness (first thickness) and an Ag layer (conductive film) having a predetermined thickness (second thickness) are repeatedly formed on the Al layer in this order. In other words, a repeating structure of “SiO₂ layer/Ag layer” is formed.

In addition, the process after the film formation step is similar to that in the manufacturing method of Embodiment 1. In this manner, for example, the flake may be configured with the repeating structure of the “SiO₂ layer/Ag layer”. In addition, the configuration of the repeating structure is not limited to the description above, and a material other than SiO₂ may be used as the insulating film (buffer layer), and a material other than Ag may be used as the conductive layer. In addition, it is also possible to configure the flake by using a multilayer film of organic substances as a repeating structure.

### Modification Example

In addition, by changing the shape or the structure of the dimming member according to one aspect of the present disclosure, it is possible to adjust the transmittance of the light incident in the normal direction of the dimming member. For example, the transmittance depends on the thickness of the dimming member. Therefore, by appropriately setting the shape or the structure of the dimming member, it is possible to appropriately change the transmittance (hereinafter, referred to as transmittance upon shielding) of the light in a case where the dimming member shields the light.

For example, in a case of manufacturing the dimming member by the manufacturing methods of the above-described Embodiments 1 to 3, by reducing the thickness (film thickness) of the dimming members, it is possible to increase the transmittance upon shielding of the dimming member. In addition, in a case of manufacturing the dimming member by the manufacturing method of the above-described Embodiment 4, by increasing the number of the repeating structures (the number of times of repetition of lamination), it is possible to reduce the transmittance upon shielding of the dimming member.

In this manner, in the dimming member (for example, at least one of the first dimming member or the second dimming member), it is possible to increase the transmittance upon shielding of the light (at least one of the light in the first wavelength range and the light in the second wavelength range) to be higher than 0.

Therefore, in a case of shielding the light (external light) of any wavelength region incident on the dimming device according to one aspect of the present disclosure (hereinafter, referred to as a completely light-shielded state) (for example, the above-described first state in FIGS. 1 and 6), it is possible to increase the transmittance of the external light to be higher than 0%. In other words, even in the completely light-shielded state, at least a part of the external light may be transmitted. Here, the transmittance of the external light in the completely light-shielded state is also referred to as a first transmittance.

In addition, a state where the external light is transmitted by the dimming device (for example, the third state in FIG. 1 and the fourth state in FIG. 6) is referred to as a completely light-transmitted state. Here, the transmittance of the external light in the completely light-transmitted state is also referred to as a second transmittance.

In addition, the transmittance of the external light means an average of the transmittance of the light in the wavelength range of the light (external light) which is a target to which the transmittance is adjusted by the dimming device (each dimming member).

For example, in a case where the dimming device adjusts the transmittance of the near infrared light having a wavelength of 900 nm to 2500 nm, the transmittance of the external light means the transmittance of the near infrared light in the wavelength range of 900 nm to 2500 nm. In other words, the transmittance of the light (for example, visible light) having a wavelength range shorter than 900 nm and the light having a wavelength range longer than 2500 nm is not related to the transmittance of the above-described external light.

In the dimming device according to one aspect of the present disclosure, the difference between the transmittances of the external light (that is, the difference between the second transmittance and the first transmittance) between the completely light-transmitted state and the completely light-shielded state may be made equal to or less than a predetermined value.

(1) For example, the difference between the second transmittance and the first transmittance may be set to be approximately 50% or less. In this case, the transmittance of the external light in the completely light-shielded state may be made relatively small.

(2) In addition, for example, the difference between the second transmittance and the first transmittance may be set to be approximately 20% or less. In this case, the transmittance of the external light in the completely light-shielded state may be made relatively large.

In this manner, by setting the first transmittance to be greater than 0 and by making the difference between the second transmittance and the first transmittance equal to or less than the predetermined value, even in the completely light-shielded state, a certain amount (desired amount) of the external light may be transmitted.

### Embodiment 5

Embodiment 5 of the present disclosure will be described with reference to FIG. 12 as follows. In the present embodiment, a dimming system 1000 including the dimming device 100 according to Embodiment 1 will be described.

FIG. 12 is a functional block diagram illustrating a configuration of a main portion of the dimming system 1000. The dimming system 1000 includes the dimming device 100, the control unit 510, temperature sensors 520 and 530, and an illuminance sensor 540.

In the light control system 1000, the dimming device 100 is provided in the window (glass window) that partitions indoors and outdoors. In other words, the dimming device 100 functions as a smart window. The control unit 510 generally controls the operation of the dimming device 100.

In addition, the control unit 510 may control the operation of the dimming device 100 based on detection results of at least one of the temperature sensors 520 and 530 and the illuminance sensor 540. In addition, the connection between the control unit 510 and each member may be performed in a wired or wireless manner.

The temperature sensor 520 is a sensor provided indoors, and detects the indoor temperature (first temperature). In addition, the temperature sensor 520 may detect the body temperature of a person (user) who lives indoors as the first temperature. The temperature sensor 530 is a sensor provided outdoors, and detects the outdoor temperature (second temperature). As an example, the control unit 510 may control the operation of the dimming device 100 based on at least one of the first temperature and the second temperature.

As an example, a case where the first temperature is the indoor temperature is considered. For example, in a case where the first temperature is lower than a predetermined temperature (for example, 24° C.), the control unit 510 may switch the dimming mode of the dimming device 100 to a mode for transmitting the near infrared light and reflecting the mid-infrared light. Accordingly, it is possible to take the near infrared light from outdoors to indoors, and to prevent the mid-infrared light from being emitted from indoors to the outdoors. Therefore, it is possible to increase the first temperature.

Further, in a case where the first temperature is higher than the predetermined temperature, the control unit 510 may switch the dimming mode of the dimming device 100 to a mode for reflecting the near infrared light and the mid-infrared light. In this case, since it is possible to suppress the near infrared and mid-infrared light from being taken from outdoors to indoors, it is possible to lower the first temperature. In this manner, the dimming device 100 makes it possible to make the first temperature (indoor temperature) close to the predetermined temperature. In other words, it becomes possible to control the indoor temperature.

In addition, the illuminance sensor 540 is a sensor provided outdoors, and detects the illuminance of the light (for example, sunlight). As an example, in a case where the illuminance (hereinafter, referred to as detected illuminance) detected by the illuminance sensor 540 is high, it is considered that the weather is fine and that a large amount of light may be taken from indoors to outdoors. Therefore, for example, in a case where the detected illuminance is higher, the operation of the dimming device 100 may be controlled so as to further increase the transmittance of the light.

In addition, the control unit 510 may control the operation of the dimming device 100 based on both the detected illuminance and the first temperature, for example. As an example, in a case where the detected illuminance is high and the indoor temperature is low (morning time duration), the transmittance of the near infrared light may be particularly high (approximately 80% to 90%). Accordingly, since it is possible to sufficiently take the near infrared light from outdoors to indoors, it is possible to raise the indoor temperature.

Further, in a case where the detected illuminance is high and the indoor temperature is high to a certain extent (day time duration), the necessity of taking the near infrared light from outdoors to indoors is low, and thus, the transmittance of the near infrared light may be particularly low (approximately 0%).

Further, in a case where the detected illuminance becomes lower and the indoor temperature becomes lower (evening time or night time duration) compared to the day time duration, the transmittance of the near infrared light may be moderate (approximately 50%).

### Embodiment 6

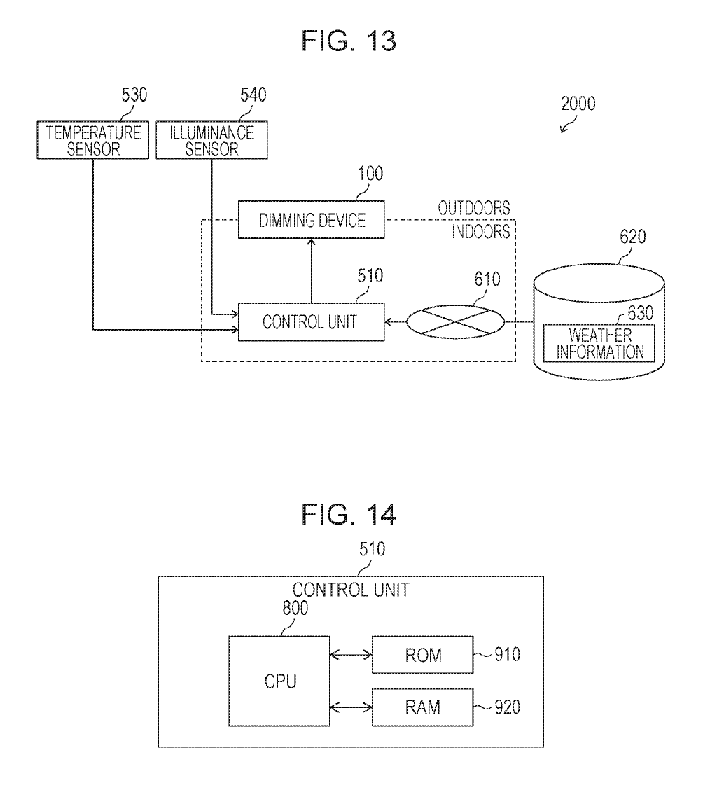

Embodiment 6 of the present disclosure will be described with reference to FIG. 13 as follows. In addition, in order to distinguish the dimming system from the dimming system 1000 of the above-described Embodiment 5, the dimming system of the present embodiment is referred to as a dimming system 2000.

FIG. 13 is a functional block diagram illustrating a configuration of a main portion of the dimming system 2000. The dimming system 2000 is different from the above-described dimming system 1000 in that (i) the temperature sensor 520 is omitted and (ii) the control unit 510 is connected to a server 620 via Internet 610.

However, the temperature sensor 520 may further be provided in the dimming system 2000. Further, the control unit 510 may not be necessarily connected to the server 620 via the Internet 610. For example, in a case where the server 620 is installed in a facility (for example, an apartment house) where the dimming device 100 is provided, the control unit 510 may be directly connected to the server 620.

Weather information 630 is stored in the server 620. The weather information 630 may be weather information provided on a website on the Internet, for example. The weather information 630 includes information indicating at least one of a change in temperature, a sunrise time, a sunset time, a change in sunshine conditions (change in weather), and the like at the current date. In addition, the weather information 630 may further include information indicating the current season.

In the dimming system 2000, the control unit 510 may control the operation of the dimming device 100 further based on the weather information 630. Accordingly, it is possible to more effectively perform the dimming by the dimming device 100. In addition, the weather information 630 may not be necessarily supplied from the server 620 to the control unit 510. As an example, the weather information 630 may be supplied to the control unit 510 by a manual input by the user.

### [Implementation Example by Software]

The control block (particularly, the control unit 510) of the dimming systems 1000 and 2000 may be realized by a logic circuit (hardware) formed in an integrated circuit (IC chip) or the like or may be realized by software using a central processing unit (CPU). In the latter case, as an example, the control unit 510 may be realized by using the configuration illustrated in FIG. 14. FIG. 14 is a functional block diagram illustrating a schematic configuration of the control unit 510.

For example, in the configuration illustrated in FIG. 14, the control unit 510 includes a CPU 800 that executes a command of a program that is software for realizing each function, a read only memory (ROM) 910 or a storage device (these are referred to as “recording medium”) in which the program and various pieces of data are recorded so as to be readable by a computer (or CPU 800), a random access memory (RAM) 920 for developing the program, and the like. In addition, the computer (or the CPU 800) reads the program from the recording medium, executes the program, and accordingly, the object of the present disclosure is achieved. As the recording medium, “non-transitory tangible medium”, for example, a tape, a disk, a card, a semiconductor memory, a programmable logic circuit, or the like may be used. In addition, the program may be supplied to the computer via any transmission medium (communication network or broadcast wave) that may transmit the program. In addition, the present disclosure may also be realized in a form of a data signal embedded in a transport wave in which the program is embodied by electronic transmission.

### CONCLUSION

In Aspect 1 of the present disclosure, there is provided a dimming device (100) that adjusts a transmittance of light by controlling an orientation of a dimming member (10), the device including: a first dimming member (flake 10A) that changes the transmittance of the light (visible light L1) in a first wavelength range in accordance with a change in an orientation state; and a second dimming member (flake 10B) that changes the transmittance of the light (near infrared light L2) in a second wavelength range in accordance with the change in the orientation state, in which, in a case where an AC voltage having a first frequency and an amplitude equal to or greater than a first amplitude is applied, the transmittance of the light in the first wavelength range is higher than that in a case where the first dimming member is oriented in a direction shielding the light, in a case where an AC voltage having a second frequency and an amplitude equal to or greater than a second amplitude is applied, the transmittance of the light in the second wavelength range is higher than that in a case where the second dimming member is oriented in a direction shielding the light, and the second amplitude is equal to or greater than the first amplitude.

According to the configuration, for example, by gradually adjusting the amplitude of the AC voltage, the orientation state (that is, the transmittance characteristics of the light) of the first dimming member and second dimming member may be individually controlled. As an example, a case where the first frequency and the second frequency are 60 Hz, the first amplitude is 2 V, and the second amplitude is 5 V, is considered. However, as described above, the first frequency and the second frequency may be different from each other, and the numerical value thereof is not limited to 60 Hz.

In this case, by applying the AC voltage having a frequency of 60 Hz and an amplitude of 2 V, the light in the first wavelength range may be transmitted by the first dimming member and the light in the second wavelength range may be shielded by the second dimming member. In addition, by applying the AC voltage having a frequency of 60 Hz and an amplitude of 5 V, the light in the first wavelength range may be transmitted by the first dimming member and the light in the second wavelength range may be transmitted by the second dimming member.

Therefore, an effect that it is possible to adjust the transmittance of the light by more various operation modes compared to the related art is achieved. In addition, the first wavelength range and the second wavelength range may be different wavelength ranges or the same wavelength range.

In the dimming device according to Aspect 2 of the present disclosure, in the above-described Aspect 1, it is preferable that at least part of the second wavelength range does not overlap the first wavelength range.

According to the above-described configuration, an effect that it is possible to adjust the transmittance for each light in the plurality of wavelength bands is achieved. Therefore, for example, in order to adjust the indoor temperature, the dimming device may be operated as a smart window.

In the dimming device according to Aspect 3 of the present disclosure, in the above-described Aspect 1 or 2, it is preferable that the first dimming member is smaller in size than the second dimming member.

As described above, in a case where the AC voltage having a predetermined frequency is applied, due to the force (orientation changing force) described from the viewpoint of the dielectrophoretic phenomenon, the Coulomb force, or the electric energy, the orientation of the first dimming member and the second dimming member may be changed. Here, the orientation of the dimming member having a smaller size is likely to change by the orientation changing force compared to the dimming member having a greater size.

Therefore, according to the configuration, an effect that it is possible to realize the first dimming member (the dimming member of which the orientation state changes by the AC voltage having the first amplitude) by the dimming member having a smaller size is achieved.

In the dimming device according to Aspect 4 of the present disclosure, in any one of the above-described Aspects 1 to 3, it is preferable that the first dimming member is smaller in density than the second dimming member.

According to the configuration, an effect that it is possible to realize the first dimming member by the dimming member having a lower density (a dimming member of which the orientation is likely to change by the orientation changing force) is achieved.

In the dimming device according to Aspect 5 of the present disclosure, in any one of the above-described Aspects 1 to 4, it is preferable that the first dimming member has a higher anisotropy than that of the second dimming member.

According to the configuration, an effect that it is possible to realize the first dimming member by a dimming member having a higher anisotropy (a dimming member of which the orientation is likely to change by the orientation changing force) is achieved.

In the dimming device according to Aspect 6, in any one of the above-described Aspects 1 to 5, it is preferable that the first dimming member and the second dimming member are dispersed inside a medium (131), and an absolute value of a difference between a dielectric constant of the first dimming member and a dielectric constant of the medium is greater than an absolute value of a difference between a dielectric constant of the second dimming member and the dielectric constant of the medium.

As described above, as the absolute value of the difference in dielectric constant between the dimming member and the medium increases, the influence of the orientation changing force on the dimming member increases. Therefore, according to the configuration, an effect that it is possible to realize the first dimming member by the dimming member having the larger absolute value of the difference in the dielectric constant from the medium (a dimming member of which the orientation is likely to change by the orientation changing force) is achieved.

In the dimming device according to Aspect 7 of the present disclosure, in any one of Aspects 1 to 6, the first frequency may be different from the second frequency.

As described above, an effect that it is possible to realize the first dimming member and the second dimming member by making the first frequency and the second frequency different from each other is achieved.

In the dimming device according to Aspect 8 of the present disclosure, in any one of claims 1 to 7, it is preferable that the first wavelength range is a wavelength range in a shorter wavelength region than the second wavelength range.

As described above, in the general usage aspect of the dimming device, it is assumed that the frequency of the adjustment of the transmittance for the light in the short wavelength region (for example, visible light region) is higher than that in the long wavelength region (for example, near infrared region or mid-infrared region).

According to the configuration, it is possible to adjust the transmittance of the light in the short wavelength range (light in the first wavelength range) by the first amplitude that is smaller than the second amplitude. In other words, a dimming mode having a higher frequency may be realized with lower power. Therefore, an effect that the power consumption of the dimming device may be reduced is achieved.

In the dimming device according to Aspect 9 of the present disclosure, in the Aspect 8, it is preferable that the light in the first wavelength range is visible light (L1), and the light in the second wavelength range is infrared light (near infrared light L2).

According to the above-described configuration, an effect that the transmittance may be adjusted for each of light beams including the visible light and the infrared light is achieved. Therefore, for example, in a case where the dimming device is operated as the smart window, the indoor temperature may be more effectively adjusted.

In the dimming device according to Aspect 10 of the present disclosure, in any one of the above-described Aspects 1 to 9, it is preferable that a third dimming member (flake 10C) that adjusts the transmittance of the light in a third wavelength range in accordance with the change in the orientation state, is further provided, in which, in a case where an AC voltage having a third frequency and an amplitude equal to or greater than a third amplitude is applied, the transmittance of the light in the third wavelength range is higher than that in a case where the third dimming member is oriented in the direction shielding the light, and the third amplitude is equal to or greater than the second amplitude.

According to the configuration, by providing the third dimming member, an effect that more various dimming controls are possible is achieved. For example, it is possible to adjust the transmittance of the visible light (light in the first wavelength range) by the first dimming member, the transmittance of the near infrared light (light in the second wavelength range) by the second dimming member, and the transmittance of the mid-infrared light (light in the third wavelength range) by the third dimming member.

In the dimming device according to Aspect 11 of the present disclosure, in any one of the above-described Aspects 1 to 10, it is preferable that, assuming that the transmittance of the light in a case of shielding the light incident on the dimming device is a first transmittance and the transmittance of the light in a case of transmitting the light incident on the dimming device is a second transmittance, the first transmittance is higher than 0, and a difference between the second transmittance and the first transmittance is equal to or lower than a predetermined value.

According to the configuration, an effect that it is possible to transmit the external light to a certain extent even in a case of shielding the light (external light) incident on the dimming device (the above-described completely light-shielded state) is achieved.

### ADDITIONAL Information

The present disclosure is not limited to each of the above-described embodiments, but various modifications are possible within the scope indicated in the claims, and embodiments obtained by appropriately combining technical means each disclosed in different embodiments are also included in the technical scope of the present disclosure. Furthermore, by combining the technical means disclosed in each of embodiments, new technical features may be formed.

### CROSS REFERENCE TO RELATED APPLICATIONS

The present disclosure contains subject matter related to that disclosed in Japanese Patent Application No. 2016-104174 filed in the Japan Patent Office May 25, 2016, the entire contents of which are hereby incorporated by reference.

### REFERENCE SIGNS LIST

10 flake (dimming member)
10A flake (first dimming member)
10B flake (second dimming member)
10C flake (third dimming member)
100 dimming device
131 medium
L1 visible light (light in first wavelength range)
L2 near infrared light (light in second wavelength range)

1. A dimming device that adjusts a transmittance of light by controlling an orientation of a dimming member, the device comprising:
a first dimming member that changes the transmittance of the light in a first wavelength range in accordance with a change in an orientation state; and
a second dimming member that changes the transmittance of the light in a second wavelength range in accordance with the change in the orientation state,
wherein, in a case where an AC voltage having a first frequency and an amplitude equal to or greater than a first amplitude is applied, the transmittance of the light in the first wavelength range is higher than that in a case where the first dimming member is oriented in a direction shielding the light,
in a case where an AC voltage having a second frequency and an amplitude equal to or greater than a second amplitude is applied, the transmittance of the light in the second wavelength range is higher than that in a case where the second dimming member is oriented in a direction shielding the light, and
the second amplitude is equal to or greater than the first amplitude.

2. The dimming device according to claim 1,
wherein at least part of the second wavelength range does not overlap the first wavelength range.

3. The dimming device according to claim 1 or 2,
wherein the first dimming member is smaller in size than the second dimming member.

4. The dimming device according to claim 1,
wherein the first dimming member is smaller in density than the second dimming member.

5. The dimming device according to claim 1,
wherein the first dimming member has a higher anisotropy than that of the second dimming member.

6. The dimming device according to claim 1,
wherein the first dimming member and the second dimming member are dispersed inside a medium, and
an absolute value of a difference between a dielectric constant of the first dimming member and a dielectric constant of the medium is greater than an absolute value of a difference between a dielectric constant of the second dimming member and the dielectric constant of the medium.

7. The dimming device according to claim 1,
wherein the first frequency is different from the second frequency.

8. The dimming device according to claim 1,
wherein the first wavelength range is a wavelength range in a shorter wavelength region than the second wavelength range.

9. The dimming device according to claim 8,
wherein the light in the first wavelength range is visible light, and
the light in the second wavelength range is infrared light.

10. The dimming device according to claim 1, further comprising:
a third dimming member that adjusts the transmittance of the light in a third wavelength range in accordance with the change in the orientation state,
wherein, in a case where an AC voltage having a third frequency and an amplitude equal to or greater than a third amplitude is applied, the transmittance of the light in the third wavelength range is higher than that in a case where the third dimming member is oriented in the direction shielding the light, and
the third amplitude is equal to or greater than the second amplitude.

11. The dimming device according to claim 1,
wherein, assuming that the transmittance of the light in a case of shielding the light incident on the dimming device is a first transmittance and the transmittance of the light in a case of transmitting the light incident on the dimming device is a second transmittance,
the first transmittance is higher than 0, and
a difference between the second transmittance and the first transmittance is equal to or lower than a predetermined value.
